(19) United States
(12) Patent Application Publication
(10) Pub. No.: US 2019/0259040 A1
(43) Pub. Date: Aug. 22, 2019

(54) INFORMATION AGGREGATOR AND ANALYTIC MONITORING SYSTEM AND METHOD

(71) Applicant: SearchSpread LLC, Montrose, CO (US)

(72) Inventor: George I. Athannassov, Colorado Springs, CO (US)

(73) Assignee: SearchSpread LLC, Montrose, CO (US)

(21) Appl. No.: 16/125,353

(22) Filed: Sep. 7, 2018

Related U.S. Application Data
(60) Provisional application No. 62/632,101, filed on Feb. 19, 2018.

(51) Int. Cl. G06Q 30/02; G06F 17/30

(52) U.S. Cl. CPC G06Q 30/0201; G06F 17/30867

(57) ABSTRACT

Data can be retrieved from multiple sources such as websites, RSS feeds, and intranet databases. The retrieved data can be processed, said processing including cleaning of advertisement content, image content, and other extraneous content. Text can be extracted from the retrieved data and a screenshot can be taken of the retrieved data in a preprocessed state. The retrieved data, processed retrieved data, and screenshot can be saved together as a retrieved data file for later retrieval. In some examples, an earlier retrieved data file can be compared to a later retrieved data file to identify and mark differences and similarities between content of the respective retrieved data files. In some examples, data can be retrieved based on a provided keyword and the resultant retrieved data file can be automatically associated with a profile or topic. The profile or topic can be updated with on a scheduled basis.

### CROSS-REFERENCE TO RELATED APPLICATION

This application is related to and claims priority under 35 U.S.C. § 119(e) from U.S. Patent Application No. 62/632,101, filed Feb. 19, 2018 entitled “INFORMATION AGGREGATOR AND ANALYTIC MONITORING SYSTEM AND METHOD,” the entire contents of which is incorporated herein by reference for all purposes.

### TECHNICAL FIELD

The present disclosure relates to data discovery and analysis across multiple, disconnected platforms.

### BACKGROUND

Many entities possess a large and often sprawling web footprint of social media, websites and web pages, affiliate sites, news websites, and myriad other presences accessible and distributed across the public Internet, private intranets, and other possible data networks, all of which may include various static and dynamic content. In many fields, such as marketing, research, recruiting, and others, it is often important to maintain up-to-date records or profiles of businesses, industries, topics, locations, and more. However, generating and maintaining records and profiles of such data can be a necessary albeit arduous task performed manually using multiple search engines, multiple data stores or brokers, and through various other means often requiring manual inputs and the like.

Further, search engines often utilize dynamic algorithms that return different results in the span of a few days due to content changes, ranking changes, user preference changes, and more. In many cases, it is difficult or impossible to return to previous search results. In industries such as, for example, marketing, sales, or other industries where monitoring leads can be critical to success, monitoring the web footprint of an entity is a manual process of actively reviewing a list of search results on a regular basis, often daily, in order to identify changes and updates related to the monitored entities.

Sales teams often also have to manually integrate targeted monitoring with industry wide monitoring and updates. Such monitoring is often accomplished through manual searches in order to retrieve new information from multiple known sources as well as through searches for information from entirely new sources. In many cases, entirely new sources may be missed at first and only discovered long after the information is useful or relevant. Further, the manual searches may take up the bulk of a salesperson's workday, which could otherwise be spent making actual sales contacts, and greatly reduce his or her efficiency. In other industries, manual monitoring in order to maintain adequate business intelligence often detracts from workers' attention to core business functionality.

It is with these observations in mind, among others, that aspects of the present disclosure were concerned and developed.

### SUMMARY

Embodiments concern data aggregation and analytic monitoring systems and methods. In a first embodiment of the invention, a method for aggregating time-associated data over multiple data sources includes executing, by a processor, a retrieval of results data from a selection of data sources, the results data corresponding to a search term and comprising one of advertisements, image content, and text data, cleaning, by the processor, the results data, the cleaning comprising removing advertisements from the results data, removing image content from the results data, extracting text content from the results data, and providing the extracted text content as cleaned results, linking with each other, by the processor, the results data, the cleaned results data, and a time of retrieval, and storing, in a data storage, the linked results data, cleaned results data, and time of retrieval.

In one embodiment, the search term comprises Boolean operators and the retrieval of the results data comprises a Boolean search based upon the search term.

In one embodiment, the method further includes linking, by the processor, a screenshot of the results data with the results data, cleaned results data, and time of retrieval, and storing, in the data storage, the screenshot.

In one embodiment, the selection data sources includes one of an RSS feed, a user intranet, a webpage, and a licensed API service.

In one embodiment, the selection of data sources includes a webpage and the method further includes identifying, by the processor, a website related to the webpage, the website comprising multiple webpages, and retrieving, by the processor, each of the multiple webpage, wherein the results data includes each of the multiple webpages.

In one embodiment, the method further includes receiving, by the processor, a schedule comprising one of a frequency and a set of one or more calendar dates, executing, by the processor, a second retrieval of a second results data from the selection of data sources based on the received schedule, cleaning, by the processor, the second results data, associating with each other, by the processor, the second results data, the cleaned second results data, and a second time of retrieval, storing, in a data storage, the associated second results data, cleaned second results data, and second time of retrieval, and identifying, by the processor, differences between the results data and the second results data by comparing the results data and cleaned results data to the second results data and cleaned second results data.

In one embodiment, the method further includes transmitting, by the processor and to a user, the identified differences.

In one embodiment, the selection of data sources comprises two or more sources and the method further includes identifying, by the processor, differences between first results data retrieved from a first source of the two or more sources and second results data retrieved from a second source of the two or more sources, and marking, by the processor, the differences.

In one embodiment, the selection of data sources comprises two or more sources and the method further includes identifying, by the processor, similarities between first results data retrieved from a first source of the two or more sources and second results data retrieved from a second source of the two or more sources, and marking, by the processor, the similarities.

### BRIEF DESCRIPTION OF THE DRAWINGS

FIG. 1 is a system diagram illustrating an information aggregator and analytic monitoring system, in accordance with various embodiments of the subject technology;

FIG. 2 is a system diagram illustrating an information aggregator and analytic monitoring system, in accordance with various embodiments of the subject technology;

FIG. 3 is a flowchart of a method for performing and processing a search across multiple sources, in accordance with various embodiments of the subject technology;

FIG. 4 is a flowchart of a method for processing a webpage, in accordance with various embodiments of the subject technology;

FIGS. 5 is a flowchart of a method for crawling a website, in accordance with various embodiments of the subject technology;

FIG. 6 is a system diagram illustrating a website crawler, in accordance with various embodiments of the subject technology;

FIG. 7 is a flowchart of a method for processing multiple data sources, in accordance with various embodiments of the subject technology;

FIG. 8 is a flowchart of a method for performing a search from a profile, in accordance with various embodiments of the subject technology;

FIG. 9 is a flowchart of a method for producing a marked search result, in accordance with various embodiments of the subject technology;

FIG. 10 is a system diagram illustrating a website monitor, in accordance with various embodiments of the subject technology;

FIG. 11 is a system diagram illustrating a comparison engine, in accordance with various embodiments of the subject technology;

FIG. 12 is an illustration of an interface for comparing multiple data sources, in accordance with various embodiments of the subject technology;

FIG. 13 is a flowchart of a method for monitoring a search output, in accordance with various embodiments of the subject technology;

FIG. 14 is a flowchart of a method for monitoring a website, in accordance with various embodiments of the subject technology;

FIG. 15 is a flowchart of a method for processing RSS data, in accordance with various embodiments of the subject technology;

FIG. 16 is a system diagram illustrating an RSS service and analysis system, in accordance with various embodiments of the subject technology;

FIG. 17 is a flowchart of a method for performing keyword searches, in accordance with various embodiments of the subject technology; and

FIG. 18 is a system diagram illustrating a computing system, in accordance with various embodiments of the subject technology.

### DETAILED DESCRIPTION

Aspects of this disclosure involve systems and methods for aggregating digital information from across various network sources and performing automated cleaning, analysis, and storage of the aggregated information. Simultaneous and instant searches can be conducted across multiple third-party publicly accessible network domains (e.g., web pages), private network domains (e.g., intranet pages), and/or other sources. Sources may include, without limitation, search engines, social media, websites, external databases, internal databases, or customized connection points provided by a user.

Retrieval and processing components store search results in a time-associated format in order to perform historical comparisons between similar search results retrieved at different times. Search results may also be retrieved individually for review and in some cases can be retrieved and/or identified based on their time-association. In some examples, the time-associated format may include a date stamp stored in metadata attached to the search results. Furthermore, comparisons can be made between sources and/or searches. For example, the system may execute a first search across a particular collection of sources and store the time-stamped results from the search, and then perform a second, identical search (e.g., using the same search query) across the same collection of sources at a later time, and stored the time-stamped results of the second search. Between the first and second search, information may have been added to or removed from the sources, the search algorithm underpinning the search may have changed, network topology may have been changed resulting in a change in availability of sources, and the like. Accessing a data store of the two sets of time-stamped search results, the search results can be compared by retrieving the older first set of search results from storage and running a comparison utility against the second set of search results.

Further, data processing components automatically store search results in a processed and/or “clean” format. Retrieval and processing components automatically retrieve search result webpages and remove advertisements, unnecessary (e.g., unrelated) images, and any source code or background scripts. The content (e.g., article text, etc.) is removed and stored for later retrieval and use. An image of the associated webpage is also stored as, for example, a screenshot and the like to provide users an “as presented” depiction of the content. As a result, users may have access to both an easily human interpretable depiction of the data in its original context, as well as a processed version of data streamlined and performant for downstream processes (e.g., comparison operations, etc.) and/or narrow review by humans.

A full scope of a search result can also be processed in that the entirety of a website may be processed through the provision of a single webpage or uniform resource locator (“URL”). A crawler may receive the webpage URL and retrieve prefixed and suffixed subdomains for automated processing, storage, and later retrieval and use by checking potential subdomains, processing internal links within the webpages of a website, and retrieving and processing a sitemap (e.g., a listing of subdomains of a website provided by the website host) if available. For example, a business landing page may be provided and then used by the crawler to identify employee profile pages, news update page, product pages, contact pages, and the like. Further, processing components may clean each subdomain and save it along with a screenshot and time-association.

Manual guidance can be removed to a preferred degree by various automated systems such as, for example, a scheduler. The scheduler can monitor a website and a crawler can regularly explore the website in order to provide significant coverage of any changes or updates. Each scheduled crawl of the website can be separately stored by the system and retrieved to, for example, compare multiple versions. Further, changes and updates can be automatically detected by the scheduled crawls and be provided to a user through a notification.

The scheduler can manage the retrieval and processing components in order to monitor for particular terms or content. The crawler may also periodically process websites and generate a notification of any updates, additions, changes, and the like related to the particular terms or content. For example, the system may be used to conduct scheduled monitoring of online information regarding a particular product. Through an interface, a user may select various sources for such monitoring including a selection of websites, social media pages, and industry news feeds. On the schedule, the system will crawl the sources and generate a notification of changes from the target sources related to the particular product. The system will also tag, clean and stored the search data. Accordingly, the system may generate comparisons between older versions of the content from the same source, such as an older version of the product webpage. The comparison may include a visual identification and explanation of the changed content by, for example, marking the content that is new or in addition to the old content or marking content that has been modified between versions.

Profiles can be constructed providing monitoring and update notifications related to particular entities. For example, a marketer may target a particular company for monitoring and schedule searches regarding various products and across various sources related to the particular company. Furthermore, multiple users can access and modify the profile to schedule and conduct searches collaboratively and as a team. The profile can also be sent to other users or exported to external applications. For example, a user may automate the transmission of profile information discovered by the monitoring process to a third party platform such as a customer relationship management (“CRM”) platform and the like through APIs, scripted exports, etc.

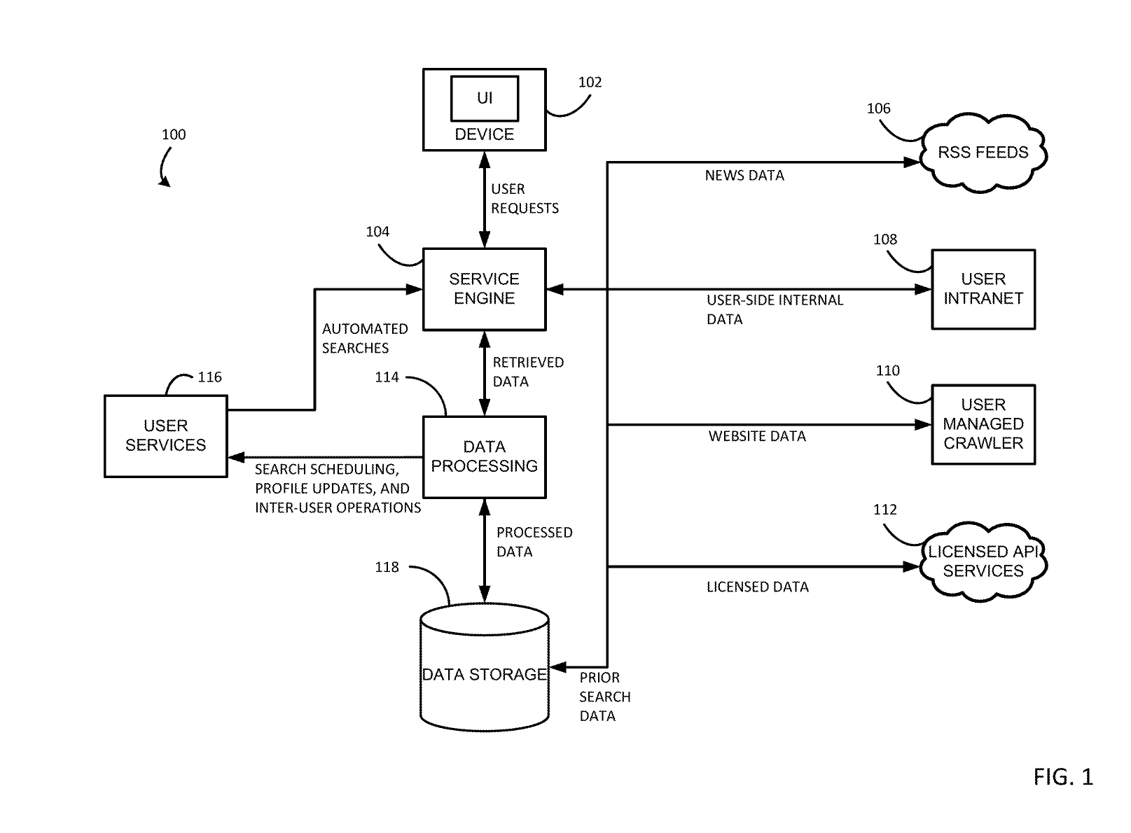

FIG. 1 depicts a search aggregation system 100 which may retrieve information from varied and disparate data sources to provide a clean, or “noiseless,” presentation of the data to the requesting user or service. The system 100 can search via multiple search engines simultaneously, as well as perform searches over social media services and other websites, to identify relevant data. The system 100 can then remove advertisements or inconsistent styles and formatting between services in order to render a clean and uniform collection of results. The search can be performed through a web portal interface and on a variety of devices. Further, the system 100 can save all results in a time-associated manner and linked with a screenshot so that histories may be compiled for review and other downstream processes (further discussed below).

A user interface (“UI”) may receive a request via a device 102. The device 102 may be a mobile device such as a smartphone, tablet, laptop, or other mobile computer device. In some examples, the device 102 can also be a personal computer or other device capable of accessing the Internet. In some examples, the request can be a Boolean search query. For example, a user searching for all mentions of John Smith in relation to New York City may construct a query as “‘John Smith’ AND ‘New York City’” or similar variations.

In some other examples, the search query may be a natural language search. Natural language searching may rely upon learned or rules-based systems, or mixes of the two, to conduct a search based on the natural language input of a user. For example, the above search for John Smith in New York City may be conducted via a natural language by simply inputting “John Smith in New York City” rather than through including Boolean operators. In some examples, a mix of Boolean search operators and natural language may be employed to construct searches.

Regardless, a service engine 104 may receive requests from the device 102. The service engine 104 may be responsible for orchestrating the search across multiple services, aggregating the results, managing the processing of the results, and providing an appropriate response back to the device 102 for the requesting user. In some cases the request may include other instructions along with the search request. For example, a user may perform a search of updated materials against a previous search utilizing the same terms.

The service engine 104 may retrieve results responsive to the requests from multiple sources 106, 108, 110, 112. When retrieving results from RSS feeds 106, the service engine 104 can retrieve news data or other update information from subscribed websites. The RSS feeds 106 can be selected by initiating the search request. In some examples, a user may select the RSS feeds 106 from a pre-generated list. In other examples, a user may provide information, such as web addresses, of the RSS feed 106 to be included in the search. In yet other examples, a combination of selected feeds from a pre-generated list and user provided feeds may be employed.

The service engine 104 can also retrieve relevant private network domain data from an intranet 108 (e.g., a user intranet). The intranet 108 may include local databases and other sources, such as an internal website or, in some examples, legacy databases or legacy systems' databases and similar data supplies. In some examples, the intranet 108 may require credentials provided to the service engine 104. In some examples, the intranet 108 can include a “safe list” which may be updated to include the service engine 104 via service identifier, IP address, or some other unique identification associated with the service engine 104.

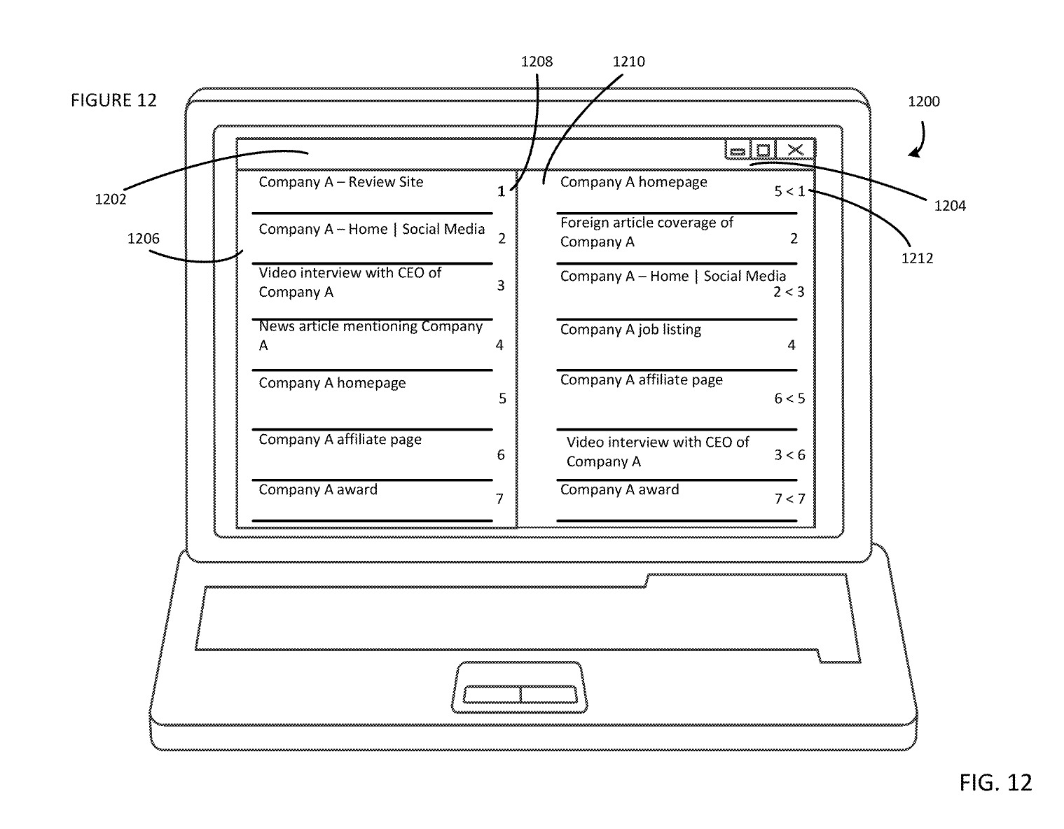

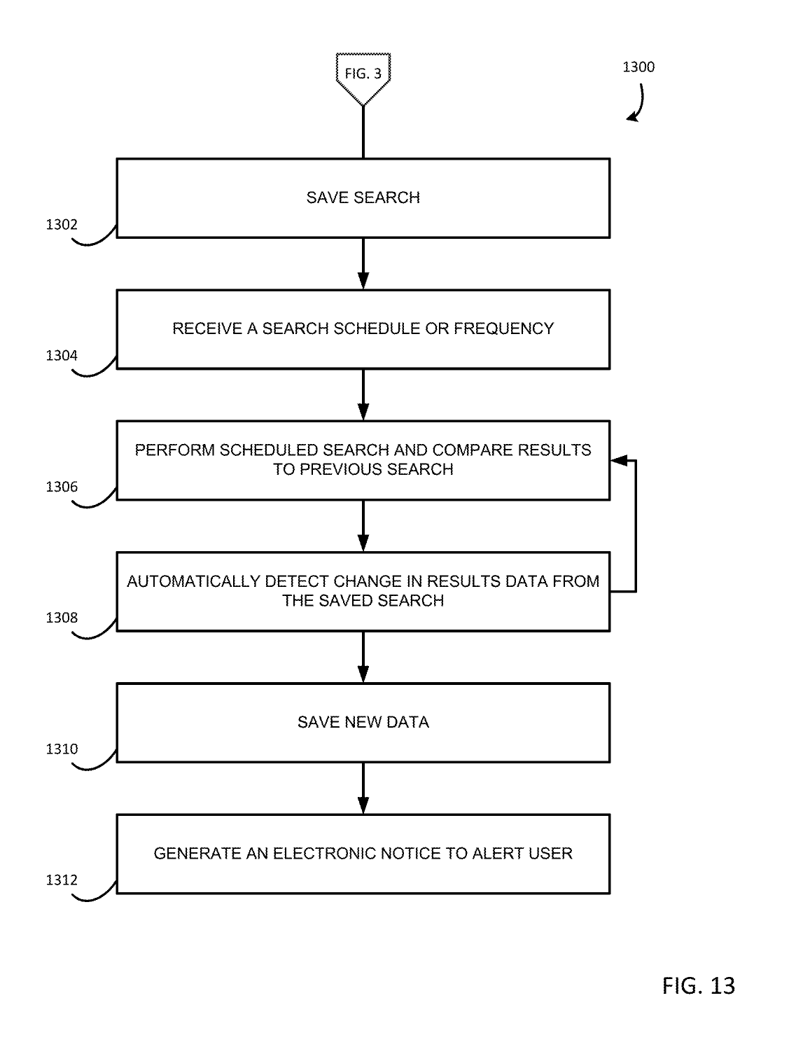

Furthermore, the service engine 104 can retrieve website data from a user managed crawler 110. Where the results are retrieved from the managed crawler 110, the service engine 104 can retrieve results from across a website by receiving a single target webpage of the website. The service engine 104 can iteratively search and explore (or “crawl”) substantial portions of the discoverable website by expanding a search from the provided page through internal link exploration, automated sitemap retrieval, and other subdomain exploration techniques (further discussed below). Systems and methods related to crawling (exploring each webpage of a website via discovery techniques) a website will be further discussed below in reference to FIGS. 12-13 of this disclosure.

The service engine 104 can also retrieve licensed data results from licensed API services 112. Licensed API services 112 can include any third party data vender who provides API access for external data retrieval. For example, a search can include Twitter® or Facebook® data feeds. Each licensed API service 112 may provide an API under a unique protocol and thus retrieving data from any particular licensed API service 112 may require a translation module tailored specifically to that service in order to properly execute searches.

Prior search data may also be provided to the service engine 104, depending on the request. For example, when a comparison search is requested, prior results can be retrieved from data storage 118 along with news data, user-side internal data, website data, and/or licensed data, as appropriate, in order for the service engine 104 to perform and present a historic comparison of search results.

Once the service engine 104 has received the results of a search, the results may be provided to a data processing service 114. The data processing service 114 can parse the different data from across different search targets to produce a form of the data that is comparable across all results regardless of origin. Further, the data processing service 114 may provide processed data as historical versions of the search results to the data storage 118 for later use and review (e.g., to perform a historical comparison against future searches, as described above).

A user services subsystem 116 can further conduct regular and automated searches and updates to data through interaction with the data processing service 114 and the service engine 104. The data processing service 114 can provide search scheduling and profiles updates, as well as inter-user operations (e.g., sharing search profiles between users and the like), to the user services subsystem 116. Further, the user services subsystem 116 can provide automated search requests to the service engine 104 according to, for example, the search scheduling received from the data processing service 114 earlier.

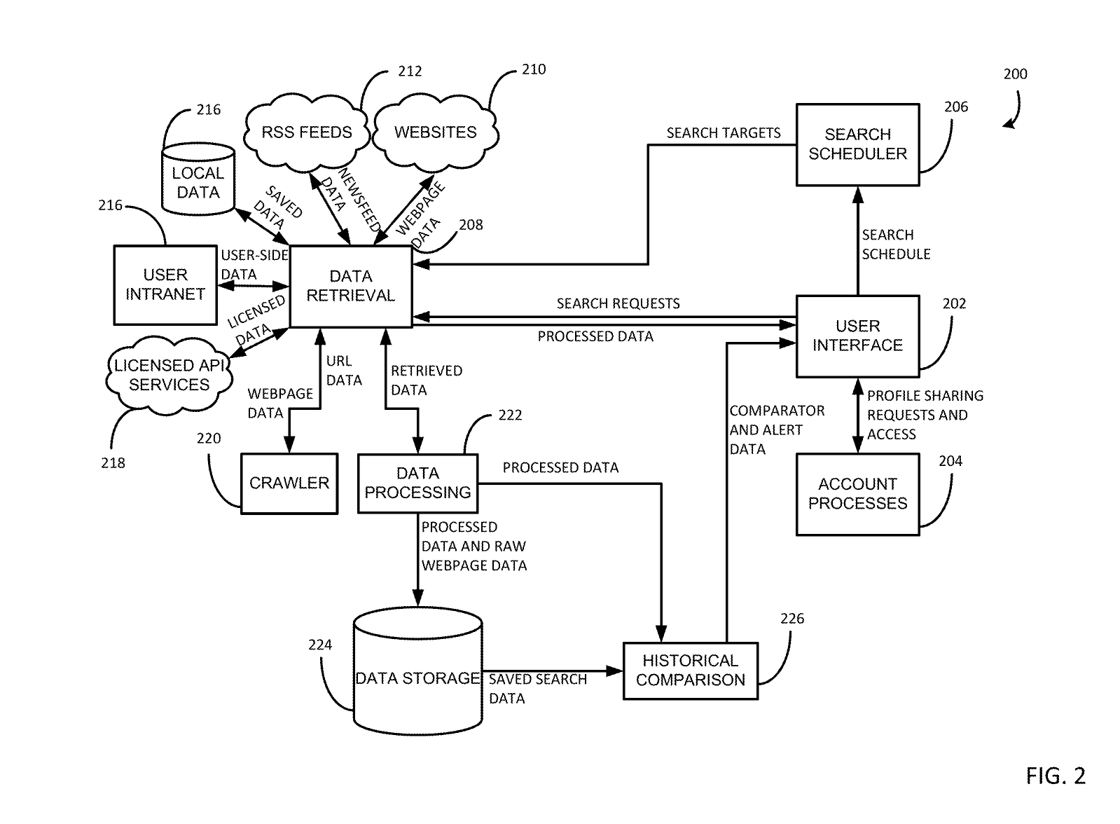

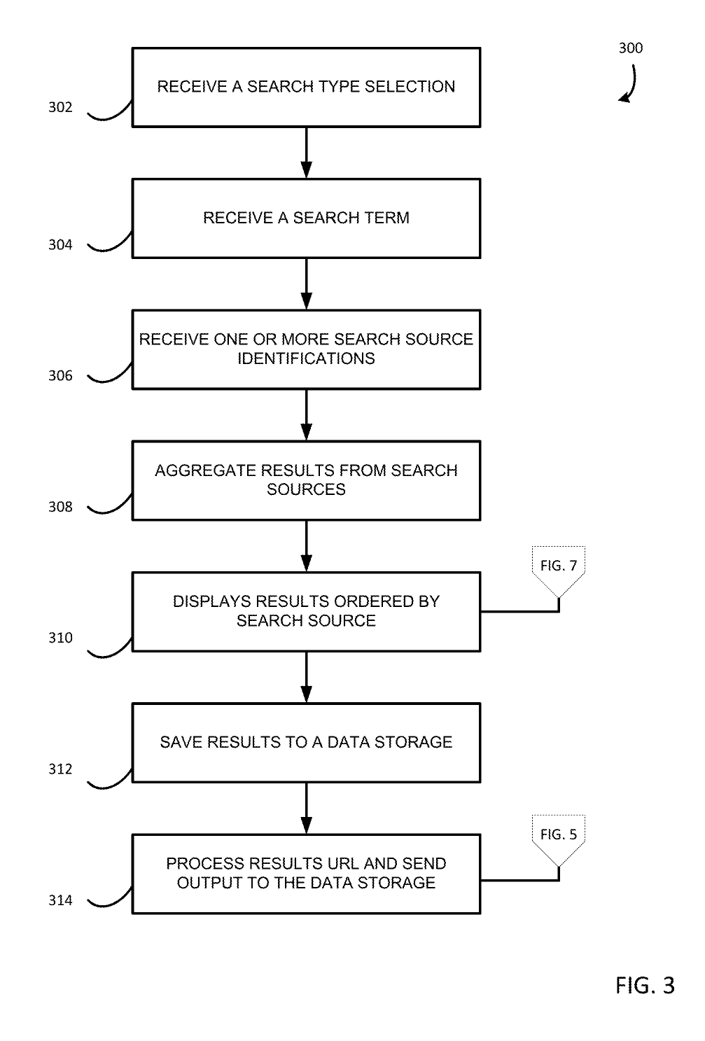

FIG. 2 and FIG. 3 depict a system 200 and method 300, respectively, for performing aggregated analytic searches. The system 200 can receive a search type selection (operation 302) through a user interface 202. Search types can be, for example, Boolean searches for an entered term and across all sources selected through a UI, an update search, or a historical comparison search. A historical comparison search may include a selection of previously conducted searches, selectable through a UI, to compare to or update. Other search types can be automatically generated based on either global or user search histories and determined preferences.

A search term can be provided (operation 304) as well as a selection of one or more search sources (operation 306) through the user interface 202. As discussed above, a search term may be a Boolean search string or, as in some examples, a natural language query. The search sources can include any or all of websites 210, RSS feeds 212, local data 214, user intranet 216, and licensed API services 218 and can be chosen via dropdown tabs and/or one or more checklists. A data retrieval service 208 may retrieve and provision results from the selected sources through various subsystems and methods (discussed below) respective to particular search source identifications.

The data retrieval service 208 can aggregate results from the selected search sources (operation 308) upon receiving a search request from the user interface 202. The data retrieval service 208 may retrieve webpage data from identified websites 210, newsfeed data from RSS feeds 212, saved data from local data 214, user-side data from the user intranet 216, and/or licensed data from licensed API services 218. The data retrieval service 208 can provide search results (e.g., webpage data, newsfeed data, saved data, user-side data, licensed data, etc.) to a data processing subservice 222 prior to returning processed data to the user interface 202 for review.

The data retrieval service 208 may, among other processes, retrieve webpage data from a provided webpage, and an associated website, by utilizing a crawler subservice 220. For example, a webpage URL can be provided to the data retrieval service 208 and initial website data can be retrieved by the data retrieval service 208 from the websites 210 (e.g., over the Internet—however, internal website data may also be crawled). The data retrieval service 208 may then provide retrieved webpage data to the crawler subservice 220 for further exploration and processing of the website of which the webpage is a part.

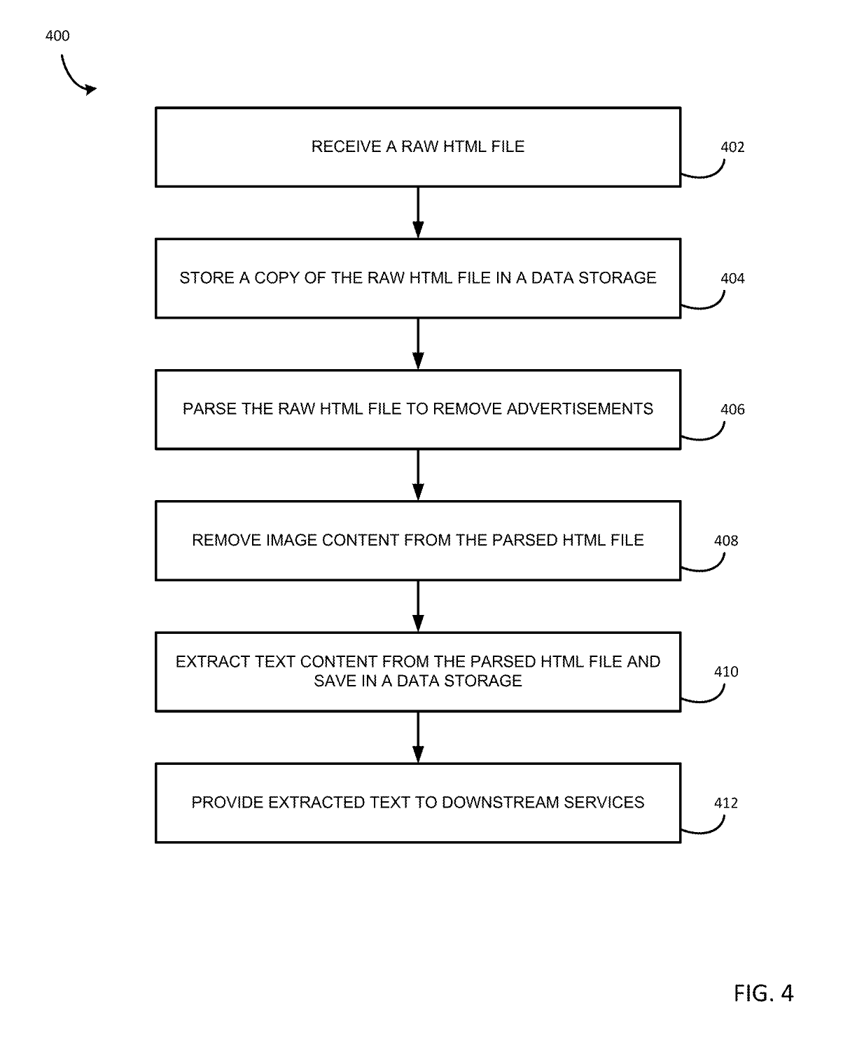

Turning to FIG. 4, a method 400 is depicted for processing a webpage retrieved by the data retrieval service 208. The data processing subservice 222 can receive an unprocessed HTML file (e.g., webpage data) retrieved by the data retrieval service 208 (operation 402). The data processing subservice 222 can provide the unprocessed webpage data to a data storage 224 (operation 404) for later retrieval and utilization. Unprocessed webpage data can include the unprocessed HTML file as well as a screenshot of the page as presented to users at the time of retrieval.

The unprocessed HTML file may then be parsed over multiple steps to prepare for downstream services and/or storage. The raw HTML file may then be parsed to remove advertisements and similar non-content components (operation 406). For example, the service 208 may include a rule or rules identifying various file attributes to remove from an HTML file. The system, applying the rule, may search the HTML file for tags identifying the attribute (e.g., a rule related to a banner advertisement) and delete the attribute from the HTML file, and store a modified file. In some examples, probabilistic or learned parsing can be utilized to identify non-content components of the unprocessed HTML file for removal.

The parsed HTML file may then be further processed to remove image content (operation 408). For example, the data processing subservice 222 may remove font styles and colors, title bars, sidebars, and the like from the parsed HTML file in order to prepare the webpage data for content extraction and to provide a “noise-free” presentation of the content. In some examples, a rules-based parsing may be employed to identify components for removal. In some other examples, probabilistic or learned parsing can be utilized to identify image content for removal from the parsed HTML file.

The parsed HTML file, having had image content and advertisements removed, may then be processed to extract text content from the parsed HTML file to be saved in the data storage 224 (operation 410). In some examples, the extracted text may be saved directly into storage. In some other examples, copies of the extracted text can be saved into storage before the original extracted text continues to be processed downstream. Further, the extracted text can then be provided to downstream services (operation 412) such as, for example, the crawler subservice 220 or back to the data retrieval service 208 for further processing or to be returned to the user interface 202 for display to a user.

A user may further save the displayed “noise-free” data to a profile (e.g., a search, company, or other entity profile) controlled or accessible by that user (not depicted). In some examples, the user may manually save the data to a profile through a context menu such as a right click menu, a drop down tab, or the like. In some examples, the user can automate the saving of cleaned data to profiles by setting key parameters which may screen data as it is cleaned and will automatically populate any profile based on the key parameters.

Further, in some examples, a search history may be stored in, for example, data storage 224 and provide a reviewable record of the search history and/or saved data. The search history can include data (e.g., search results, inputs, etc.) of a respective user from all search and data gathering activities performed by the user or, in some examples, performed by accounts and/or profiles associated with the user. Search results can then be retrieved from data storage 224 to provide processed and/or historical versions of the search results. Additionally, searches may be performed another time without having to recreate the search parameters and the like and so reducing the likelihood of incorrectly recreated searches. In some examples, the search history may be organized by retrieval type (e.g., fielded search, track web page, track website, track news, and the like).

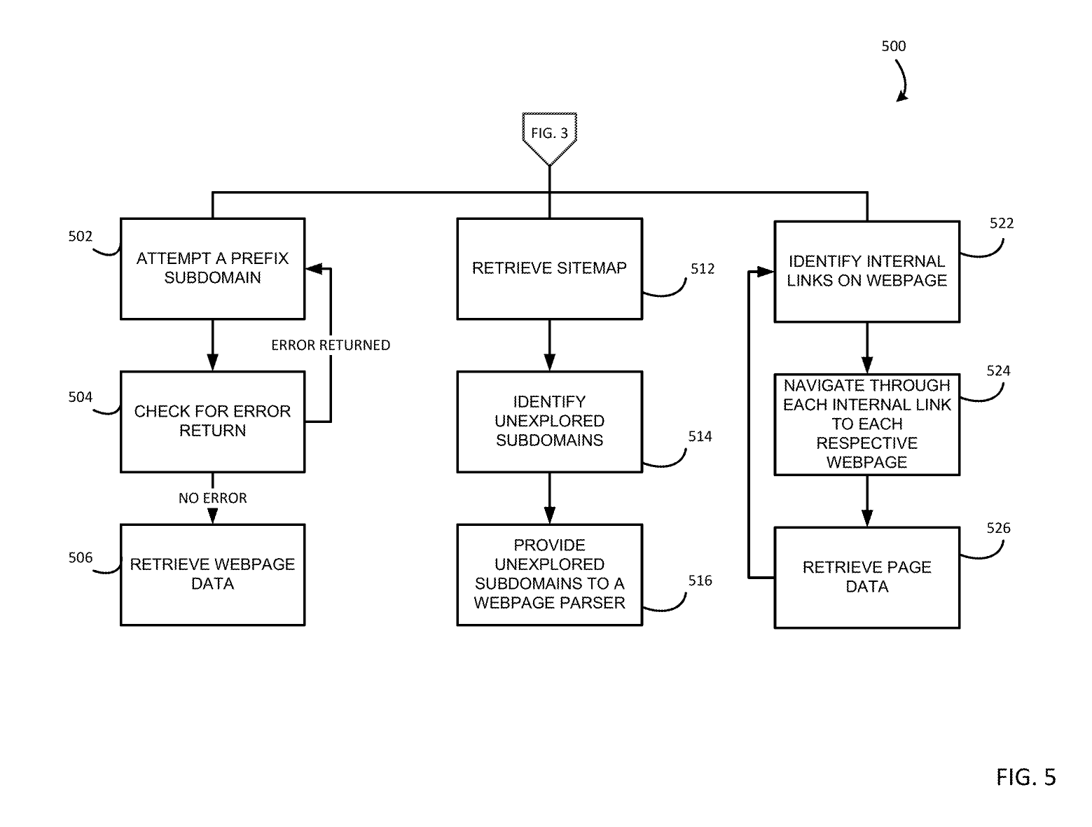

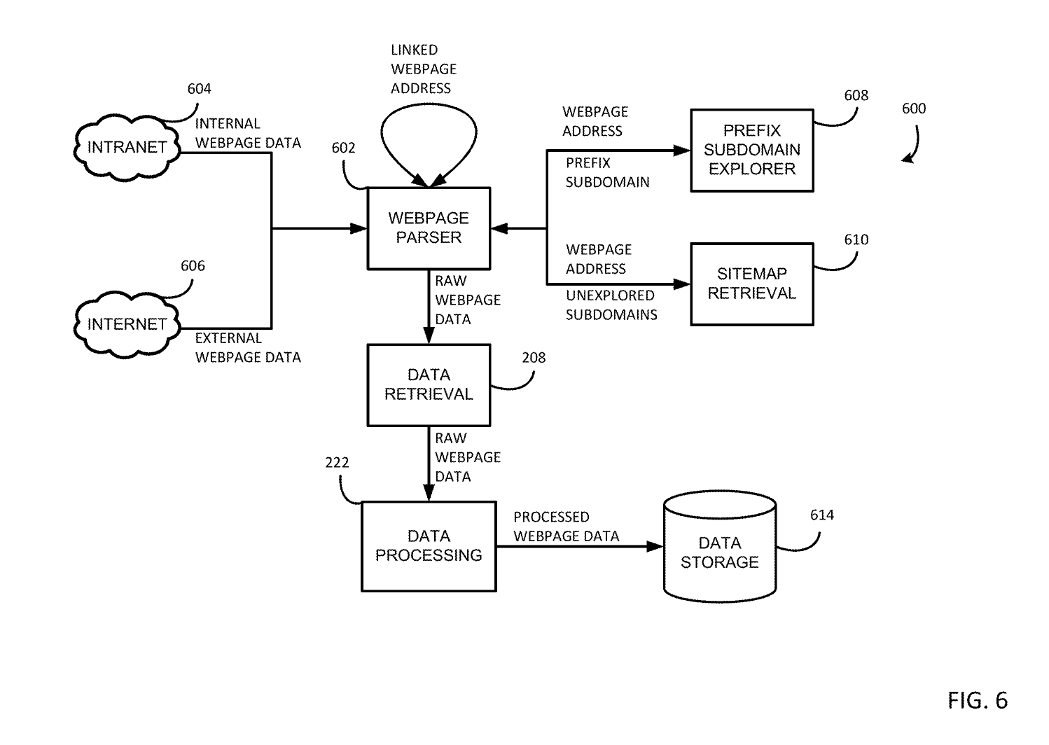

Turning to FIG. 5 and FIG. 6, a method 500 and subsystem 600, respectively, are depicted which may, in one example, constitute the crawler subservice 220. The crawler subservice 220 can allow the system 200 to retrieve data from both a single webpage and the entirety of a website associated with that single webpage by exploring all webpages contained on the site via discovery and exploration methods and systems discussed below. The system 200 may process and save each additionally retrieved webpage as discussed above.

Now, in more detail, a webpage parser 602 may receive webpage data from either the Internet 606 or an internal website on an intranet layer 604. In some examples, the webpage parser 602 may be a component of the data processing subsystem 222. In some other examples, the webpage parser 602 may be a distinct service callable by the various services and subservices of the system 200 (e.g., as in a microservices architecture). The webpage parser 602 can cycle through webpage links provided on a parser webpage and also perform subdomain exploration of the domain address of the webpage originally provided to the webpage parser 602. In other words, either or both of a breadth first or a depth first exploration of a graph of the website can be performed in order to fully crawl the website from a provided webpage and identify any relevant data contained on webpages which may have otherwise been ignored due to not being directly specified as a data source. While the exploration of websites is discussed herein in terms of URL look ups (e.g., accessing a server hosting a domain or subdomain via a URL), it is understood that the same steps and systems may perform look ups through the Domain Name System (“DNS”) by providing addresses to a DNS server in lieu of or in tandem with URL look ups.

More particularly, the webpage parser 602 may perform three processes, sequentially and/or in parallel, to crawl a website. In one example, the webpage parser 602 itself may identify the internal links on the webpage under review (operation 522). In on example, all links may be identified using a rules-based process identifying links by a respective HTML tag (e.g., the “<a href=>” tag and the like) and checking whether the link contained in the HTML tag correlates with the webpage upon which it is found. Each identified internal link is then traversed in order to retrieve a respective webpage (operation 524). The respective webpages may then be parsed by the webpage parser 602 (operation 526). This can be done iteratively or recursively depending on performance parameters of the system. In some examples, links that have already been explored, such as where multiple webpages link back to the same single webpage (e.g., a link back to the landing page of a website), can be exempt from being explored multiple times in order to avoid infinite loops and speed up execution time.

In parallel or sequentially, the webpage parser 602 may provide the webpage address to a prefix subdomain explorer 608 and a sitemap retrieval service 610. The sitemap retrieval service 610 can retrieve a sitemap from a website associated with a provided webpage (operation 512). In some examples, the sitemap provides a listing of webpages included in a website and may be provided for indexing purposes related to various search engines (e.g., Google®, Bing®, and the like). The sitemap retrieval service 610 can retrieve the sitemap by attempting to locate it at commonly used subdomains. In one example, the sitemap retrieval service 610 can then identify unexplored subdomains of the website (operation 514) using a listing of webpages provided by the retrieved sitemap. A list of explored subdomains may be provided to all subsystems and services of the crawler 220 in order to determine whether or not a particular subdomain has been explored. In some examples, the crawler 220 can operate in a multithreaded or multiprocessor (e.g., parallelizable) fashion and the list of explored subdomains may be provided as a shared resource. In some other examples, each process may implement individual copies of an explored list which is updated according to a certain frequency or threshold parameter. In yet other examples, the search may be performed iteratively and in sequence and so the list may be filled by each subservice as it is performed in sequence.

The prefix subdomain explorer 608 can attempt a prefix subdomain (operation 502). A prefix subdomain includes a trailing URL component prepended onto the domain URL. For example, “contact.mywebsite.com” may be a prefix subdomain with “contact” being the prefix to the “mywebsite.com” domain. The prefix subdomain explorer 608 can retrieve prefixes from a pre-constructed list of commonly (and/or uncommonly) used prefixes. In some examples, a probabilistic mapping can be used so highly unlikely prefixes are not attempted.

The prefix subdomain explorer 608 can then check for an error to be returned (operation 504). If an error is returned, the prefix subdomain explorer 608 can attempt a new prefix, otherwise (e.g., if an error is not returned) the data retrieval service 208 may retrieve the webpage data (operation 506). The data retrieval service 208 can provide the retrieved webpage data back to the webpage parser 602 to continue exploring the website as well as to the data retrieval service 208 for further processing by the data processing subservice 222 and storage in the data storage 614.

A sitemap is a preferred practice but is not a required element of a webpage. By employing both the webpage parser 602 and the prefix subdomain explorer 608 alongside the sitemap retrieval service 610, the crawler 220 can capture subdomains not otherwise listed on the sitemap or not otherwise clearly available to those accessing a website. Further, because all webpages are eventually run through the webpage parser 602, whether they are discovered by the prefix subdomain explorer 608 or the sitemap retrieval service 610, a substantial amount of webpage data from the website may be provided to the data retrieval service 208 and further downstream.

Returning briefly to FIG. 2 and FIG. 3, after aggregating a results from the search sources (operation 308), the system 200 may display the search results ordered by respective search source via the user interface 202 (operation 310). Further, or instead, other visual presentations of processed data may be provided through the user interface 202 as discussed in further detail below. From the user interface 202, results can be saved to profiles, searches can be saved, an automated search schedule can be planned, and other account access modifications may be performed such as sharing profiles and search results to other users or exporting data for use with third-party vendors or internally. The search results may also be automatically saved to the data storage 224 (operation 312), regardless of whether the results are saved to a profile. The saved search results may consist of the raw HTML file along with a screenshot of the rendered file. Further, the saved results can be processed by the data processing subservice 222 and crawler subservice 220 and stored for later retrieval and review (operation 314). For example, saved processed data can be used to perform a comparison of a website search to historical views of the website even if a user has not performed themselves perform the relevant search.

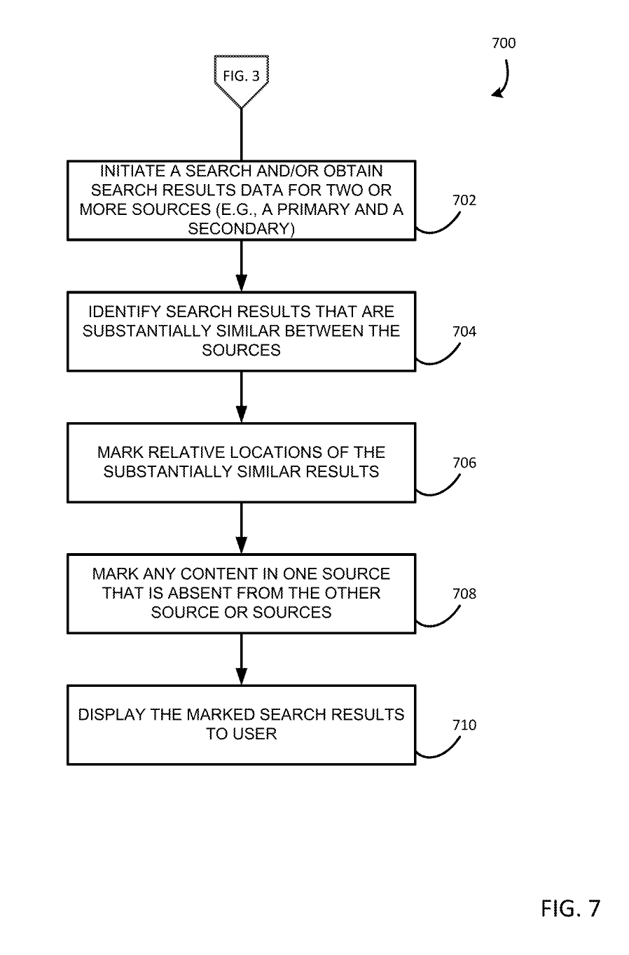

From the user interface 202, a user can review comparisons between search sources or perform comparisons against historical search results. Comparisons between search sources may be performed by the data retrieval service 208 whereas comparisons against historical search results can be performed by a historical comparison service 226 which may retrieve previously conducted searches that are similar to a considered current search. Turning to FIG. 7, a comparison method 700 is depicted for comparing search results between two or more different sources.

A search can be initiated or search results can be otherwise obtained for a comparison such as through reviewing the aggregated search results of operation 308 discussed above (operation 702). The two sources may be, for example, two search engines. For example, a search can be conducted selecting Bing® and Google® among the search sources. The provided search terms will be used to perform searches on both engines which may provide different results based on their respective search algorithms.

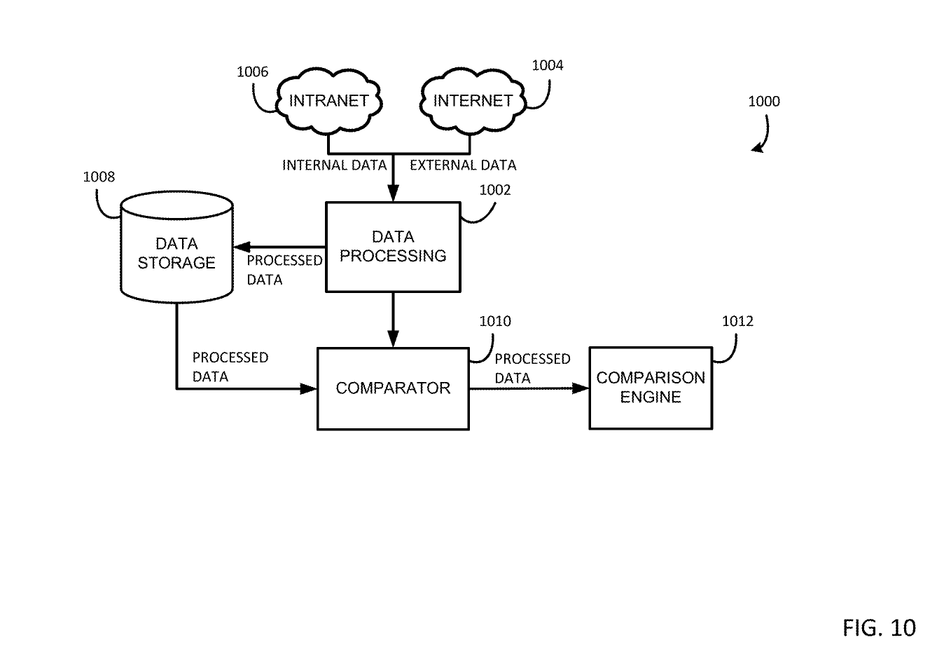

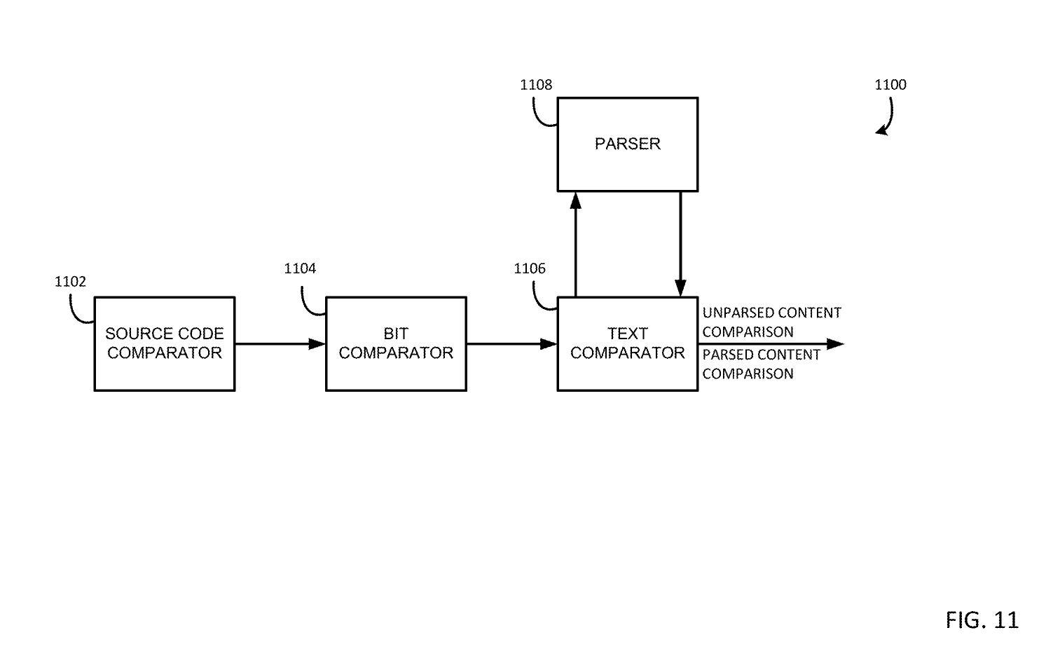

A comparator service may identify search results that are substantially similar between respective sources (operation 704). Identification of both similar and disparate search results can be achieved through the comparator service implementing a comparison engine or the like, as discussed below in references to FIG. 10 and FIG. 11. For example, where Bing® and Google® both return an identical top result for a search, that top result may be identified as identical between the two services. Further, for example and without imputing limitation, where Bing® returns a top result that is identical to the 8^{th} result return by Google®, the shared result here, too, can be identified.

In either case, the relative locations of the substantially similar results may be marked (operation 706). In some examples, the mark may constitute a numerical identification providing where in the sequence of returned results, relative to the source, each respect result was returned from along with matching results. For example, the top result returned by Bing® may be marked with a “1” denoting the result as the first returned result. Similarly, the 8^{th} result returned by Google® can be marked with an “8” denoting it as the 8^{th} returned result. Further, the 8th returned result from Google® can be further marked with a “1” to denote the substantial similarity between the compared results, creating a combined marking of, for example, “1<8” and the like (as will be further discussed below in particular reference to FIG. 12).

Content that is found in one source but absent in other sources may also be marked (operation 708). For example, the marking may be a color highlight applied to the respective content. In some examples, content that is substantially similar but also contains differences between sources may be both numerically marked as above as well as contain content highlights denoting differences. The marked content can then be provided to the user interface 202 to be displayed (operation 710).

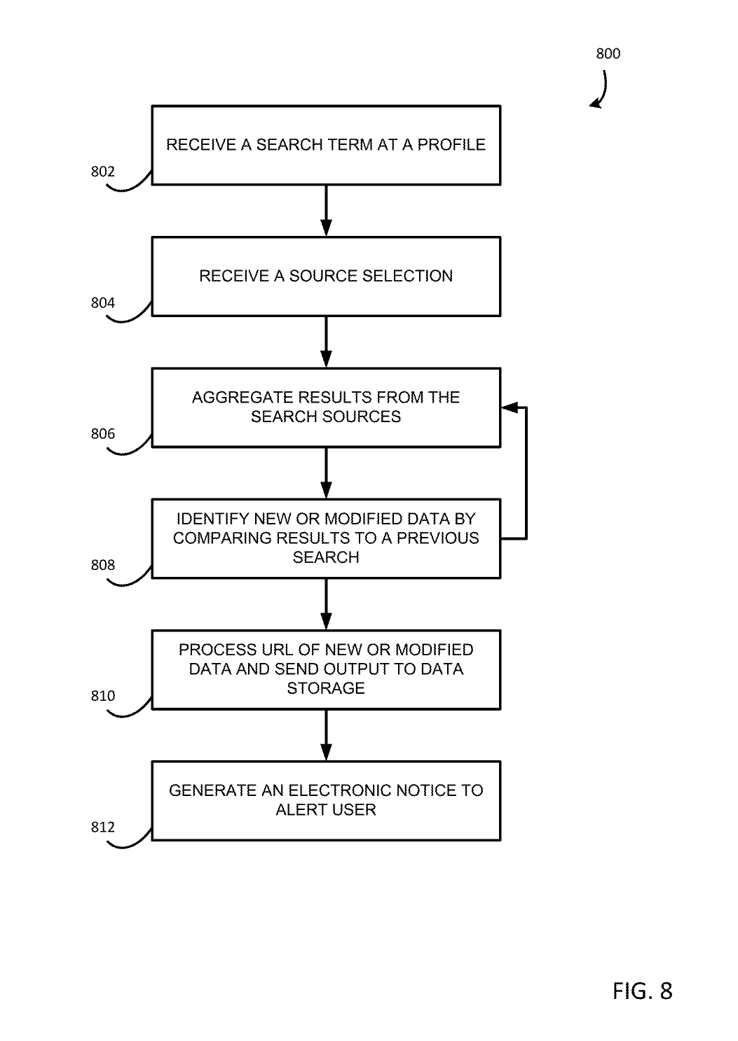

In some examples, a user can utilize either or both of the search scheduler 206 or the account processes 204 to perform regular updates and/or alerts along search terms and to particular search profiles. FIG. 8 depicts a method 800 to generate a profile update along search terms. A profile can be associated with an individual (e.g., a marketing profile for utilization with a CRM or similar service), a corporation or other company, or a particular industry or topic and can be accessed through the account processes 204 as profiles may be associated with particular user accounts. For example, a user may regularly run searches for roofers in Boston by running a Boolean search for “roofers AND Boston” over Bing® and Google® as well as multiple social media platforms (e.g., Facebook®) in order to track changes in the Boston roofing industry.

The profile page may receive a search term (operation 802). The search term may be any of the term constructions discussed above (e.g., Boolean, natural language, etc.) and the profile may receive a new one or be associated with the search term itself. “Roofers AND Boston” is one example of such a search term.

A source selection can also be provided (operation 804) in order to specify what searchable services and platforms are retrieved from. This allows, for example, a user to strictly limit the provision of results and updates in order to ensure consistent data collection techniques across a span of time, among other benefits. For example, the search for “roofers AND Boston” can be performed over Bing®, Google®, and Facebook®. As discussed above, multiple websites, licensed API services, search engines, intranet resources, local data, and RSS feeds can be utilized together in various fashions to perform a search.

The data retrieval service 208 may aggregate results from the selected search sources (operation 806) in similar fashion to methods and systems discussed above. Further, by comparing results to a previous search (retrieved from data storage), the historical comparison service may identify new and modified search results (operation 808). The historical comparison service 226 can use a comparison subsystem to perform the identification of new and modified search results (discussed below in reference to FIG. 10). When conducted in response to a request from the search scheduler 206, the aggregation (operation 806) and identification (operation 808) of data can be conducted automatically at a predetermined frequency.

The URL of each new or modified result may be processed and the resultant output can be stored in the data storage 224 (operation 810) in similar fashion as discussed above. For example, the URLs of the results may be provided to the crawler subservice 220 to perform further website exploration and updates as appropriate. Further, an electronic notice can be generated and transmitted (operation 812). The electronic notice can be either or both of an email or similar offline alert or a comparison page as discussed above generated in response to a user performing a manual profile update.

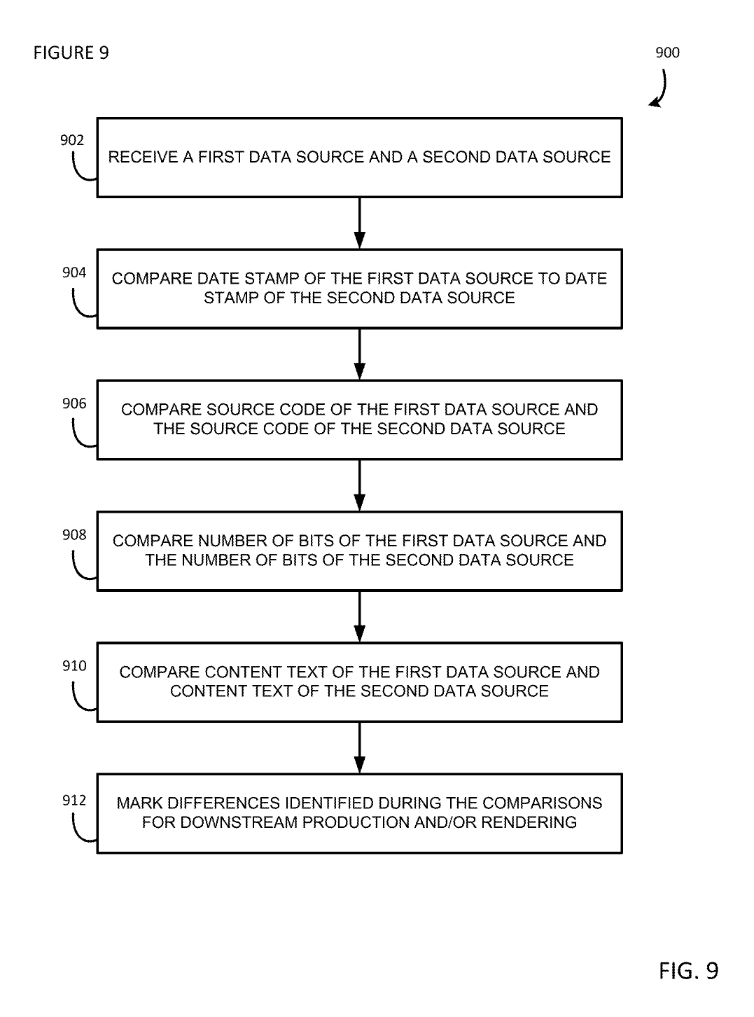

Turning to FIG. 9, FIG. 10, and FIG. 11, a method 900, system 1000, and subsystem 1100, respectively, are depicted for performing comparisons between results data. In some examples, comparisons can be performed by both the data processing subservice 208 and the historical comparison service 226, where the latter may access saved search data from the data storage 224 to compare a current search request against prior search requests. In some examples, an intermediary orchestrator may conduct comparisons between searches and/or search results, retrieving data from data storage or the data retrieval service 208 as appropriate.

A data processing module 1002 (in some examples, the data processing subservice 222) may receive both internal data via a user intranet 1006 and external data via the Internet 1004. The data processing module 1002 may receive a first data source and a second data source (operation 902) and, after processing the retrieved data as discussed above, store processed data from the first and second data source in a data storage 1008 (in some examples, the data storage 224). The processed data can then be provided to a comparator service 1010 for further analysis by a comparison engine 1012. Where a search is compared to historical data, the comparator service 1010 may receive a historical search results data from the data storage 1008 and, where searches retrieved from two or more different data sources are compared to each other, the comparator service 1010 can receive the processed data directly from the data processing module 1002.

In any case, the comparator service 1010 may provide the appropriate processed data to a comparison engine 1012. The comparison engine 1012 may then perform the remaining operations of the comparison method 900 by first receiving the processed data at a source code comparator 1102 which may first compare a data stamp of the first data source to a date stamp of the second data source (operation 904) in order to, for example, determine a priority or temporal hierarchy between sources in the case of a historical comparison. In some examples, where the results of two data sources are retrieved from a single search, a date stamp comparison may be skipped.

The source code comparator 1102 may then compare source code of the first data source and source code of the second data source (operation 906). In some examples, the source code comparison may perform a string comparison of each line, identifying different characters and strings contained on each line of source code (or, alternatively, identifying identical characters and strings). Where strings or characters are identified as being in different locations within the line but otherwise identical, the differing interim material may be identified as new material. A bit comparator 1104 may then receive data from the source code comparator 1102 in order to compare the number of bits of the first data source and the number of bits of the second data source (operation 908).

A text comparator 1106 may then receive the processed source code in order to compare the content text of the first data source and the content text of the second data source (operation 910). In some examples, the content text may be processed by the text comparator first in an unparsed manner (e.g., as the raw HTML file) and then again in a parsed manner (e.g., the HTML file having had ads and image content removed). Where the text comparator 1106 processes the content text following a parse, it may first be provided to a parser 1108 and processed as discussed above before being returned to the text comparator 1106 for comparing content text between the two parsed data sources.

Afterwards, identified differences between the two data sources may be marked and provided to downstream services (operation 912) such as the user interface 202 for rendering on a display or to an export service provided by the account processes 204 for providing data to services external to the system 200. Where the historical comparison 226 is run through an automated schedule (e.g., by the search scheduler 206), the identified differences may be provided to the user interface 202 as a comparator alert such as in an email or an update message viewable through a web portal. In some examples, differences are only marked after aggregating the comparisons of the source code comparator 1102, bit comparator 1104, and text comparator 1106, determining whether a difference identified by any one component of the comparison engine 1100 based on an aggregation of the components' analyses. In some other examples, identified differences may be marked as they are identified at each component and continue downstream.

Where identified differences between two search sources for a single search are provided to a user interface 202, a view 1200, depicted in FIG. 12, may be rendered. The view 1200 may be provided to a user via a web portal on a laptop, smartphone, desktop computer, or other computing device with a visual display. The view 1200 includes a first screen portion 1202 and a second screen portion 1204. The first screen portion 1202 may include a first search results list 1206 including respective content text for each search result retrieved from a particular data source (e.g., Google®, Bing®, Facebook®, Twitter®, Instagram®, etc.) and may also include a respective numeric mark 1208 denoting an ordering as determined by the respective data source. For example, the top result returned by Google® may include a “1” next to it, denoting that the result was the topmost result retrieved from Google® whereas the result immediately below may be marked with a “2” denoting that it is the second from the top result.

The second screen portion 1204 may include a list 1210 providing the search results retrieved from a second data source. The second list 1210 may also include a mark 1212 associated with each respective search result. The mark 1212 may include both the ordering in which the result was provided by the respective data source, and also a numeric identifier associated with the location of a matching search result in the list 1206. For example, as depicted by FIG. 12, the first search result of the second portion 1210 is “Company A homepage” and is marked “5<1” in order to identify both its place as the topmost result from its respective data search as well as “Company A homepage” being the fifth from the top result returned by the search source of the first list 1206.

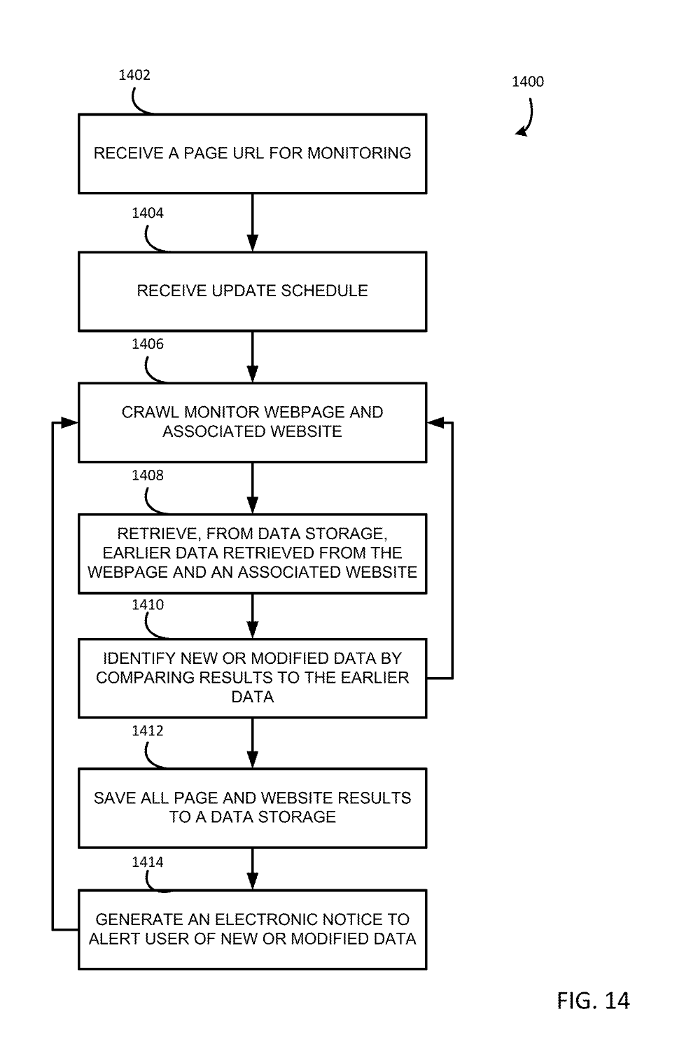

Turning to FIG. 13 and FIG. 14, a scheduled search method 1300 and a monitoring method 1400 are depicted which may be available through either or both of the search scheduler 206 and the account processes 204. A user may schedule an automated search via a new search or a recently conducted search. In either case, the search may be saved (operation 1302). A saved search may be conducted later either manually or automatically.

Once a search has been saved, a search schedule or frequency can be received (operation 1304) via the user interface 202 and search scheduler 206. In some examples, a search frequency may include, without limitation, daily, weekly, monthly, and other options. In some examples, specific days may be chosen for searches to be conducted. For example, a marketing researcher may select Friday evenings for automated searches in order to take advantage of Friday even press cycles.

The automated search may be performed according to the selected schedule and the results of that search may be compared against the most recent search conducted by the same schedule (operation 1306). In some examples, the comparison may be performed by the historical comparison service 226 as discussed above. As a result of the comparison, any changes in results data relative to a preceding search may be automatically detected (operation 1308). This same process may be repeated according to the provided search schedule parameters. In some examples, the automated search may further provide results to the crawler subservice 220 in order to identify the full scope of updates throughout a website associated with a webpage returned by the search results.

Any changes or modifications may be saved as new data (operation 1310) to the data storage 224. Further, an electronic notice may be provided as an alert to the creator the search schedule (operation 1312). In some examples, alert settings may allow teams or specified groups of users to be alerted by changes and new material discovered during an automated search.

FIG. 14 depicts a monitoring method 1400 for webpages and associated websites. A user may designate a particular webpage to monitor and receive alerts and notifications when new content or modifications to existing content are detected. For example, a user may monitor the website of a competing company by providing the URL of the landing page of the website rather than designating each and every page to monitor. The monitoring service may be accessed through the account processes service 204 and the user interface 202.

A URL of a webpage to be monitored may be first received (operation 1402). For example, the URL of the landing page of a website (e.g., http://www.mycompany.com and the like) can be provided. In some examples, a user can further select whether to monitor the entirety of the website associated with the webpage or just the webpage provided.

An update schedule may then be received (operation 1404). A frequency can be selected at which to receive alerts and notifications of detected content updates. In some examples, the system may aggregate updates that are regularly detected at a predetermined frequency and provide the aggregated updates at the selected frequency. For example, a user may choose to be updated only once a month; however, the website may be checked daily for content changes and all such changes may be compiled into an ultimate list to provide to the user at the end of the month.

The crawler 220 may then explore the webpage and associated website according to a schedule (operation 1406). As discussed above, the crawler 220 may explore all subdomains of the website via retrieval of an associated sitemap, link exploration, and subdomain exploration algorithms. As a result, newly added subdomains (e.g., a new profile page of a newly hired employ, etc.) and associated content can be retrieved along with content from previously known subdomains.

Earlier webpage data may be retrieved from the data storage 224 (operation 1408) in order to perform respective content comparisons. In some cases, a webpage may have been retrieved and processed from an earlier search. In other cases, a webpage may be entirely new and therefore will only contain new content because there is no preceding version for comparison. In some examples, previous versions of webpage may be retrieved globally from the data storage 224. In other words, any previous search providing a version of the webpage may provide a version for comparison, regardless of whether the search was conducted by the relevant user, thereby enabling users to be notified of new or updated content even if they have not performed the same webpage retrieval earlier.

The data provided by the crawler subservice 220 may be compared with the retrieved data from the data storage 224 by, for example, the comparator service 1010 in order to identify new or modified data (operation 1410). The comparator service 1010 may process all data with the comparison engine 1012 as discussed above. All results may then be saved to the data storage 224 (operation 1412) for later retrieval and use. For example, the newly retrieved data can be used as an earlier version for a later conducted crawl of the website. In some examples, all data retrieved can be saved, whether or not it is duplicative of earlier results, in order to preserve a time-associated snapshot of the website for later review. In some examples, duplicative data may instead be mapped in order to minimize storage costs.

An electronic notice may be generated to alert, for example, a user of the new or modified data (operation 1414). In similar fashion to methods discussed above, the alert notice may contain a summary of detected changes and updates and may be in the form of an email or external communication system or provided through a web portal client and accessed via the account processes service 204.

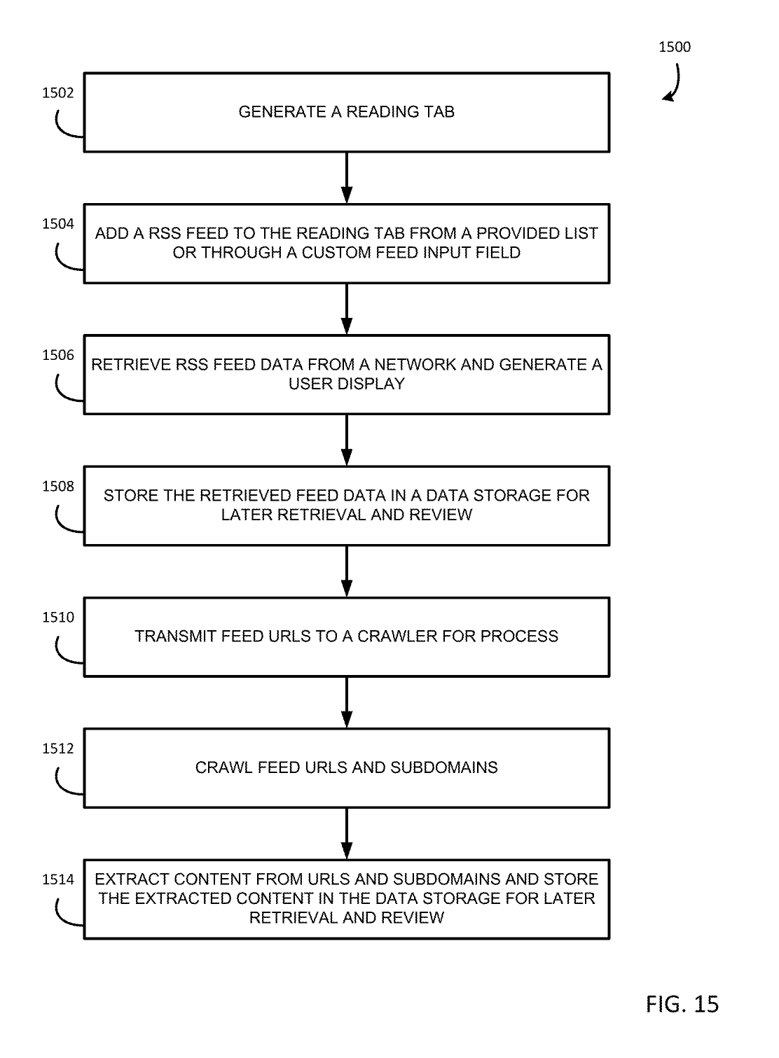

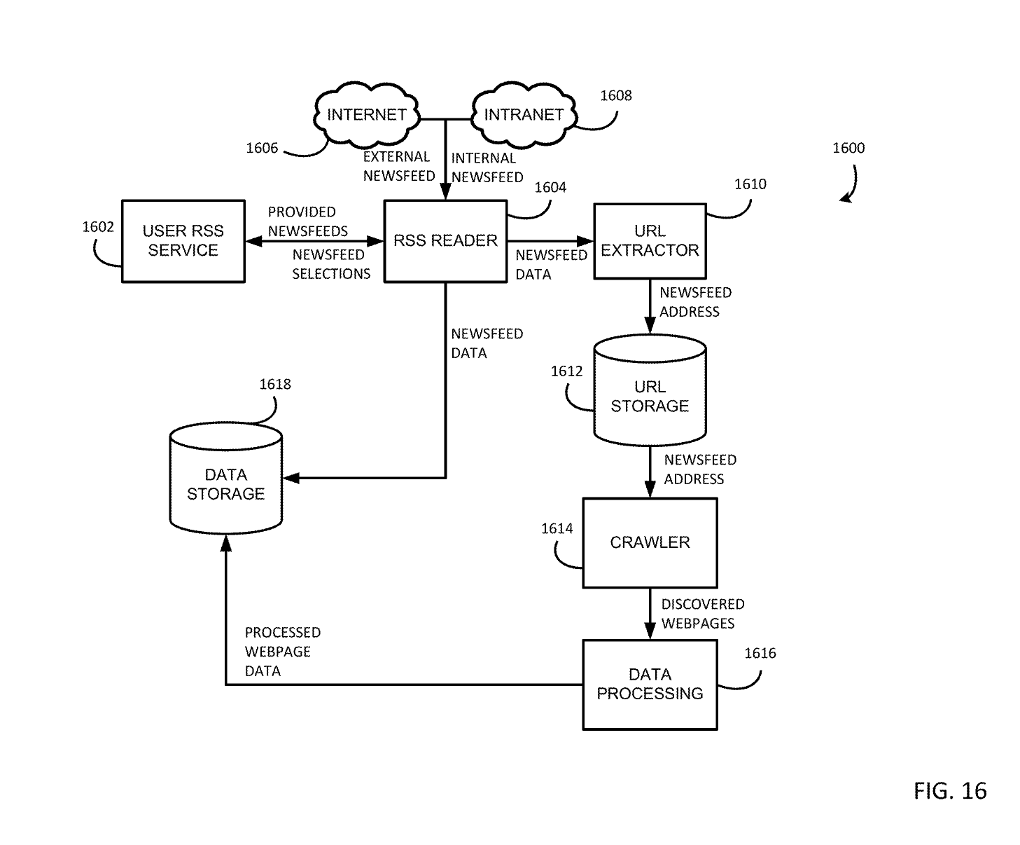

Turning to FIG. 15 and FIG. 16, an RSS retrieval method 1500 and system 1600 are depicted which may provide newsfeed data to a user retrieved from RSS feeds 212. RSS data is generally a newsfeed data source provided by a reporting outlet or through a website (such as a company website) news page. A particular RSS feed may be a subdomain of a larger website.

A reading tab may be generated (operation 1502) for by a RSS service 1502. The RSS service 1502 may itself be provided by the account processes service 204 and the user interface 202. The reading tab may provide a feed, or series of chronologically sorted updates, from already subscribed RSS sources. In some examples, a default feed may be provided. In some examples, a default feed may also be custom generated based on past searches and other data. In some other examples, a blank RSS feed may be provided by default until other feeds are subscribed to.

RSS feeds can be added to the reading tab from either a provided list or by inputting a URL into a fillable field (operation 1504). A preconstructed list of feeds may be provided. The list may be a generic list and organized according to genre, topic, region, and the like or may be constructed based on account information and the like. The fillable field may receive a URL related to a feed and may automatically retrieve the feed from the URL and add it to the reading tab. In some examples, the provided URL may be any URL on a webpage having a RSS feed and the system 1600 may discover any available RSS feeds on the website (for example, by using the crawler subservice 220 as discussed above).

Having received RSS feed selections, a RSS reader 1604 may retrieve RSS feed data from the Internet or a user intranet in order to provide updated information back to the RSS service 1602 for display (operation 1506). The retrieved RSS feed data may be provided to a URL extractor 1610 in order to extract the relevant URL from the feed. For example, a feed with the subdomain URL “http://www.mywebsite.com/rss” may be processed by the URL extractor 1610 to retrieve the URL of the domain “http://www.mysebsite.com” for storage in a URL storage 1612 and other downstream use. Further, the RSS data itself may be stored in a data storage 1618 in a versioned format for later use by, for example, the historical comparison service 226 (operation 1508). In some examples, the data storage 1618 and the URL storage 1612 may both be included in the data storage 224 as part of a system-wide data storage system.

The URL of each RSS feed may be provided to a crawler 1614 (operation 1510) for exploration of the related website. In some examples, the crawler 1614 can be the crawler subservice 220 in order to reduce redundancies within the system. The crawler 1614 may then crawl each website associated with each feed URL (operation 1512).

As discussed above in reference to the crawler subservice 220, the crawler 1614 may provide each discovered webpage to a data processing service 1616 which, in some examples, may be the data processing subservice 222. The data processing service 1616 may extract content from the crawled websites and store the extracted content in the data storage 1618 for later use (operation 1514).

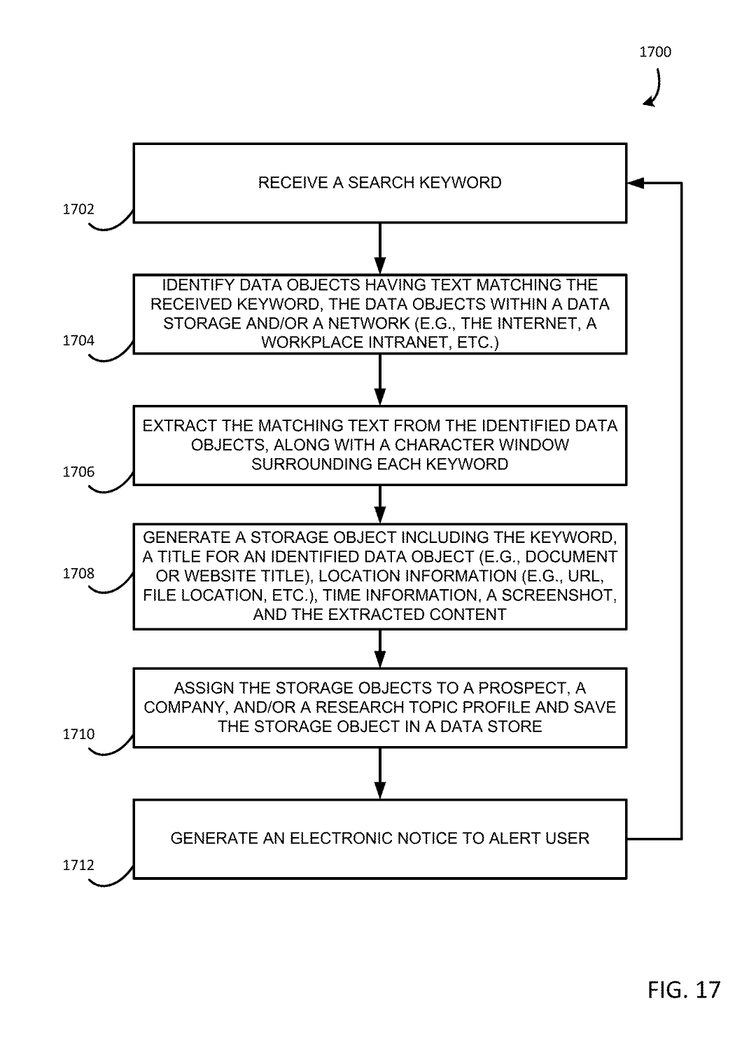

FIG. 17 depicts a keyword search method 1700 for updating, for example, data storage 224 and/or a prospect, a company, or a research topic profile. Keyword search method 1700 can be performed once or on a regular basis according to a schedule maintained by, for example, search scheduler 206 (discussed above).

A keyword may first be received for performing a search (operation 1702). The keyword can be provided by a user via user interface 202 or be a previously stored keyword provided as a result of an automated or scheduled process. The keyword can be a single word or may instead be a phrase or sequence of words which are to be matched identically and in the provided order.

System 200, for example, can then use the keyword to identify data objects at some network, which data objects include the keyword (e.g., based on a string search within a text component of the data object and the like) (operation 1704). Data retrieval service 208 and data processing service 222, for example, can retrieve and identify the data objects using the methods and systems discussed above.

Text matching the keyword may then be extracted along with text of a character window around the keyword (operation 1706). For example, data processing service 222 may extract the keyword and surrounding text from each identified data object that is provided to it. The character window may be of various sizes, such as, for example and without imputing limitation, 500 characters before and after the identified keyword. In some examples, the user may provide the character window. In such an example, the system extracts the keyword, the 500 characters preceding the keyword and 500 characters following the keyword.

In some examples, data processing service 222 may generate a storage object for the identified data object and the storage object can include various information regarding the identified data object (operation 1708). For example, the storage object may include, without imputing limitation, the keyword, a title for the identified data object, location information (e.g., a URL or a file location) where the identified data object was found, time information for when the data object was identified, a screenshot, and the extracted text content (e.g., including text within the character window). The included information can be retrieved and/or generated by data processing service 222 according to the methods and systems discussed above.

The storage object can then be assigned to a particular profile such as a prospect, a company, or a research topic profile (operation 1710). In some examples, the storage object may be assigned to multiple profiles and/or profile types. For example, a processed keyword search result could be assigned to both a company profile and also a profile of a CEO (e.g., a prospect) of the company.

Further, an electronic alert can be generated for sending to the user performing the search or otherwise associated with the keyword search (e.g., a team of multiple users, etc.) (operation 1712). Method 1700 may also be repeated on a regular basis by, for example, scheduler 206 and the like as part of a scheduled search.

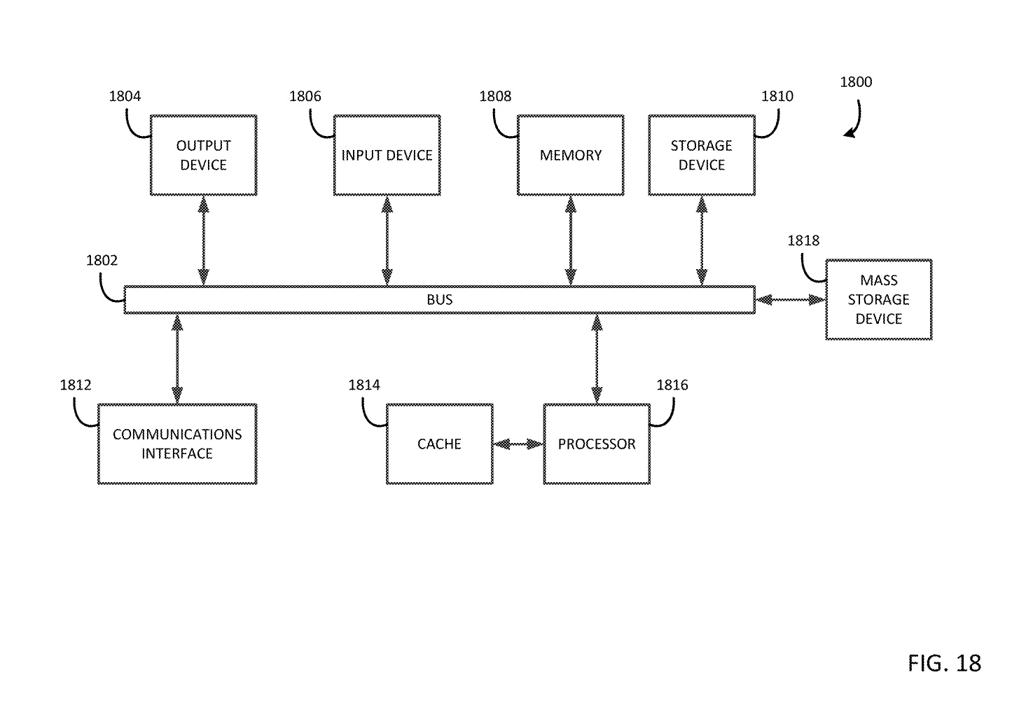

FIG. 18 is an example computing system 1800 that may implement various systems and methods discussed herein. The computer system 1800 includes one or more computing components in communication via a bus 1802. In one implementation, the computing system 1800 includes one or more processors 1816. The processor 1816 can include one or more internal levels of cache (not depicted) and a bus controller or bus interface unit to direct interaction with the bus 1802. The processor 1816 may specifically implement the various methods discussed herein. Memory 1808 may include one or more memory cards and a control circuit (not depicted), or other forms of removable memory, and may store various software applications including computer executable instructions, that when run on the processor 1816, implement the methods and systems set out herein. Other forms of memory, such as a storage device 1810 and a mass storage device 1818, may also be included and accessible, by the processor (or processors) 1816 via the bus 1802. The storage device 1810 and mass storage device 1818 can each contain any or all of the methods and systems discussed herein. In some examples, the storage device 1810 or the mass storage device 1818 can include a versioned storage repository in order to provide the data storage 224 discussed above.

The computer system 1800 can further include a communications interface 1812 by way of which the computer system 1800 can connect to networks and receive data useful in executing the methods and system set out herein as well as transmitting information to other devices. The computer system 1800 can also include an input device 1706 by which information is input. Input device 1806 can be a scanner, keyboard, and/or other input devices as will be apparent to a person of ordinary skill in the art. The system set forth in FIG. 18 is but one possible example of a computer system that may employ or be configured in accordance with aspects of the present disclosure. It will be appreciated that other non-transitory tangible computer-readable storage media storing computer-executable instructions for implementing the presently disclosed technology on a computing system may be utilized.

In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the methods can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a computer-readable storage medium having stored thereon instructions, which may be used to program a computer system (or other electronic devices) to perform a process according to the present disclosure. A computer-readable storage medium includes any mechanism for storing information in a form (e.g., software, processing application) readable by a computer. The computer-readable storage medium may include, but is not limited to, optical storage medium (e.g., CD-ROM), magneto-optical storage medium, read only memory (ROM), random access memory (RAM), erasable programmable memory (e.g., EPROM and EEPROM), flash memory, or other types of medium suitable for storing electronic instructions such as cloud based services including, without limitation, both virtualized and non-virtualized solutions.

The description above includes example systems, methods, techniques, instruction sequences, and/or computer program products that embody techniques of the present disclosure.

However, it is understood that the described disclosure may be practiced without these specific details.

While the present disclosure has been described with references to various implementations, it will be understood that these implementations are illustrative and that the scope of the disclosure is not limited to them. Many variations, modifications, additions, and improvements are possible. More generally, implementations in accordance with the present disclosure have been described in the context of particular implementations. Functionality may be separated or combined in blocks differently in various examples of the disclosure or described with different terminology. These and other variations, modifications, additions, and improvements may fall within the scope of the disclosure as defined in the claims that follow.

What is claimed is:

1. A method for aggregating time-associated data, the method comprising:
retrieving, by a processor, results data from a data source, the results data stored in a results data file and corresponding to execution of a search of the data source using a search term at a time of retrieval, the results data comprising at least one of an advertisement content, an image content, and a text content;
generating a cleaned results data comprising the text content of the results data without the advertisement content or the image content; and
storing the cleaned results data in the results data file with the results data and the time of retrieval.

2. The method of claim 1, wherein the cleaned results data is generated by:
receiving a copy of the results data;
deleting the advertisement content from the copy of the results data;
extracting the text content from the copy of the results data with the advertisement deleted; and
providing the extracted text content as a cleaned results data.

3. The method of claim 1, wherein the search term comprises Boolean operators and the retrieval of the results data comprises a Boolean search based upon the search term.

4. The method of claim 1, wherein the search term comprises a key phrase, the key phrase including one or more words, and the retrieval of the results data comprises string search based upon the search term.

5. The method of claim 4, wherein the results data includes a character window comprising a selected range of characters preceding the key phrase and the selected range of characters following the key phrase.

6. The method of claim 1, further comprising:
generating, by the processor, a screenshot of the results data as rendered on a web browser; and
storing, in the results data file, the screenshot.

7. The method of claim 1, wherein the selection of data sources includes one of an RSS feed, a user intranet, a webpage, and a licensed API service.

8. The method of claim 1, wherein the selection of data sources includes a webpage and the method further comprises:
identifying, by the processor, a website related to the webpage, the website comprising multiple webpages; and
retrieving, by the processor, copies of each of the multiple webpages;
wherein the results data includes the copies of each of the multiple webpages.

9. The method of claim 1, further comprising:
receiving, by the processor, a schedule comprising one of a frequency and a set of one or more calendar dates;
executing, by the processor, a second retrieval of a second results data from the selection of data sources based on the received schedule;
cleaning, by the processor, the second results data;
storing, in a second results data file, the second results data, the cleaned second results data, and a second time of retrieval; and
identifying, by the processor, differences between the results data and the second results data by comparing the results data and cleaned results data to the second results data and cleaned second results data.

10. The method of claim 9, further comprising transmitting, by the processor and over a network connection to a user, the identified differences.

11. The method of claim 1, wherein the selection of data sources comprises two or more sources and the method further comprises:
identifying, by the processor, differences between results data retrieved from a first source of the two or more sources and second results data retrieved from a second source of the two or more sources; and
marking, by the processor, the differences by flagging portions of the results data retrieved from the first source of the two or more sources and corresponding portions of the second results data retrieved from the second source of the two or more sources.

12. The method of claim 11, wherein identifying differences comprises:
comparing extracted text from results data retrieved from the first source of the two or more sources to extracted text from results data retrieved from the second source of the two or more sources; and
marking locations within the compared text corresponding to distinct text between the results data.

13. The method of claim 1, wherein the selection of data sources comprises two or more sources and the method further comprises:
identifying, by the processor, similarities between first results data retrieved from a first source of the two more or more sources and second results data retrieved from a second source of the two or more sources; and
marking, by the processor, the similarities by flagging portions of the results data retrieved from the first source of the two or more sources and corresponding portions of the second results data retrieved from the second source of the two or more sources.

14. A non-transitory computer readable medium storing instructions which, when executed by one or more processors, cause the one or more processors to:
retrieve results data from a data source, the results data stored in a results data file and corresponding to execution of a search of the data source using a search term at a time of retrieval, the results data comprising at least one of an advertisement content, an image content, and a text content;
generate a cleaned results data comprising the text content of the results data without the advertisement content or the image content; and
store the cleaned results data in the results data file with the results data and the time of retrieval.

15. The non-transitory computer readable medium of claim 14, storing instructions which further cause the one or more processors to:
receive a copy of the results data;
delete the advertisement content from the copy of the results data;
extract the text content from the copy of the results data with the advertisement deleted; and
provide the extracted text content as a cleaned results data.

16. The non-transitory computer readable medium of claim 14, wherein the search term comprises Boolean operators and the retrieval of the results data comprises a Boolean search based upon the search term.

17. The non-transitory computer readable medium of claim 14, wherein the search term comprises a key phrase, the key phrase including one or more words, and the retrieval of the results data comprises string search based upon the search term.

18. The non-transitory computer readable medium of claim 17, wherein the results data includes a character window comprising a selected range of characters preceding the key phrase and the selected range of characters following the key phrase.

19. The non-transitory computer readable medium of claim 14, storing instructions which further cause the one or more processors to:
generate a screenshot of the results data as rendered on a web browser; and
store, in the results data file, the screenshot.

20. The non-transitory computer readable medium of claim 14, wherein the selection of data sources includes one of an RSS feed, a user intranet, a webpage, and a licensed API service.

21. The non-transitory computer readable medium of claim 14, wherein the selection of data sources includes a webpage, and storing instructions which further cause the one or more processors to:
identify a website related to the webpage, the website comprising multiple webpages; and
retrieve copies of each of the multiple webpages;
wherein the results data includes the copies of each of the multiple webpages.

22. The non-transitory computer readable medium of claim 14, storing instructions which further cause the one or more processors to:
receive a schedule comprising one of a frequency and a set of one or more calendar dates;
execute a second retrieval of a second results data from the selection of data sources based on the received schedule;
clean the second results data;
store, in a second results data file, the second results data, the cleaned second results data, and a second time of retrieval; and
identify differences between the results data and the second results data by comparing the results data and cleaned results data to the second results data and cleaned second results data.

23. The non-transitory computer readable medium of claim 22, storing instructions which further cause the one or more processors to transmit, over a network connection to a user, the identified differences.

24. The non-transitory computer readable medium of claim 14, wherein the selection of data sources comprises two or more sources, storing instructions which further cause the one or more processors to:
identify differences between results data retrieved from a first source of the two or more sources and second results data retrieved from a second source of the two or more sources; and
mark the differences by flagging portions of the results data retrieved from the first source of the two or more sources and corresponding portions of the second results data retrieved from the second source of the two or more sources.

25. The non-transitory computer readable medium of claim 24, wherein identifying differences comprises:
comparing extracted text from results data retrieved from the first source of the two or more sources to extracted text from results data retrieved from the second source of the two or more sources; and
marking locations within the compared text corresponding to distinct text between the results data.

26. The non-transitory computer readable medium of claim 14, wherein the selection of data sources comprises two or more sources, storing instructions which further cause the one or more processors to:
identify similarities between first results data retrieved from a first source of the two more or more sources and second results data retrieved from a second source of the two or more sources; and
mark the similarities by flagging portions of the results data retrieved from the first source of the two or more sources and corresponding portions of the second results data retrieved from the second source of the two or more sources.
